(19) United States
(12) Patent Application Publication
(10) Pub. No.: US 2015/0161553 A1
(43) Pub. Date: Jun. 11, 2015

(54) METHODS AND SYSTEMS RELATING TO TIME LOCATION BASED EMPLOYEE MANAGEMENT SYSTEMS

(71) Applicant: Punchtime Inc., Alexandria (CA)

(72) Inventor: Yves Eggleston, Alexandria (CA)

(21) Appl. No.: 14/527,036

(22) Filed: Oct. 29, 2014

Related U.S. Application Data
(60) Provisional application No. 61/912,301, filed on Dec. 5, 2013.

(51) Int. Cl. G06Q 10/06; H04W 4/00; H04W 4/02

(52) U.S. Cl. CPC G06Q 10/063114; H04W 4/021; H04W 4/008

(57) ABSTRACT

A method is provided, including establishing through a web based interface a geo-fenced region, the geo-fenced region established in dependence upon a worksite location; monitoring through a wireless based location means whether a user is within or external to the geo-fenced region, the wireless based location means using a wireless receiver operating according to a first predetermined standard forming part of an electronic device associated with the user; and associating the user with the worksite location in dependence upon whether the user is within the geo-fenced region associated with the worksite location and storing with each association the time elapsed between the user's entry and exit from the geo-fenced region.

### CROSS-REFERENCE TO RELATED APPLICATIONS

This application claims the benefit of 35 USC 119(e) priority of U.S. Patent Application 61/912,301 filed Dec. 5, 2013 entitled “Methods and Systems Relating to Time Location Based Employee Management Systems.”

### FIELD OF THE INVENTION

This invention relates to time and activity management systems and more particularly to systems and methods exploiting automatically acquired time and location in isolation or in combination with sensor data such as accelerometers.

### BACKGROUND

Tracking workers' time has been a necessity since workers began working on an hourly basis or business charged on an hourly basis or tracked labour costs on an hourly basis. Historically, hourly time tracking was achieved using the punch clock system in which a time card was assigned to each worker where upon commencing work, the worker had his or her card punched by a clock so that the work starting time could be recorded. Then, upon ceasing work, the worker had his or her card punched again so that the work ending time could be recorded. From these starting and stopping times, a record could be constructed for a period, etc. This record was then used in preparing a paycheck for the worker and in creating other records relating to the time worked by a partial or complete work force.

Originating from the factory environment in which all workers worked in a single location, the punch clock worked well. Even with multiple factories an enterprise could manage very large geographically distributed workforces. However, without fixed locations, employees other than factory floor workers, distributed mobile workforces time keeping was more difficult where a workforce was distributed. Further, other developments in the workforce such as employment agencies who specialize in placing workers in contract positions within different organizations and also have their own employees. A contract employee, while being paid by an employment agency, reports to an employer (usually a supervisor) within the company. Accordingly, the contract employee creates a time sheet based upon the work they perform, passes the time sheet to their supervisor at the company for approval, and then once approved the time sheet is passed to the employment agency. The employment agency then produces a paycheck for the employee and bills the company for the employee's time.

Another difficulty relating to time keeping relates to distributed work forces. Distributed work forces are now the norm, instead of the exception, not only for employment agencies but for companies as well. In a distributed work force, employees/contractors may be distributed worldwide with temporary, part-time and full-time employees with flexible work schedules, flexible locations, etc. Each employee/contractor is required to submit time sheets for each pay period. Organization of time records is another difficulty faced in time keeping for many organizations as whilst employees may work for a single company, the employees may work for different divisions, in different departments, and for different supervisors within the same department. Time records must be segregated according to this organizational structure for accounting and budget tracking purposes. Further, in an employment agency scenario, the employment agency may service tens or hundreds of companies. While each of the contractors works for, and is paid by the employment agency, invoices must be submitted to the appropriate company. Further, within a particular company, a single contractor may work on more than one project, in more than one division, and for more than one supervisor. The contractor's time must be segregated accordingly when the invoice is submitted. To further complicate this effort, the contractor may be paid at different rates for this work, depending upon the project, division, etc. These complexities further increase the difficulty in not only paying the employee but in generating an invoice for the company.

These issues have resulted in multiple prior art solutions exploiting a variety of electronic time sheet systems. However, similar issues arise for all organizations from small to large and even for those without any fixed office apart from the owner's house. For example, even a small building contractor with two or more active projects employing a few employees will need to track them to allocate time and costs to the projects to either invoice the clients or understand whether they have made or lost money on the contract. However, the prior art solutions have been geared primarily to desk based employees wherein ease of use, location tracking, activity tracking, etc. are not primary drivers but rather entry of complex project and task codes together with time tracking to hundredths of a hour (e.g. to an accuracy of 36 seconds).

At the same time with employees, contractors, temporary staff etc. performing multiple tasks on multiple projects each day the supervisory role becomes extremely difficult to verify that a particular individual did actually perform the task they say they did and took the length of time that they say they did.

Thus, there is a need in the art for a time and location tracking system that overcomes the shortcomings cited above as well as other shortcomings of the prior systems.

Other aspects and features of the present invention will become apparent to those ordinarily skilled in the art upon review of the following description of specific embodiments of the invention in conjunction with the accompanying figures.

### SUMMARY

It is an object of the present invention to mitigate drawbacks within the prior art relating to time and activity management systems and more particularly to systems and methods exploiting automatically acquired time and location in isolation or in combination with sensor data such as accelerometers.

In accordance with an embodiment of the invention there is provided a method comprising:
establishing a geo-fenced region, the geo-fenced region established in dependence upon a worksite location;
assigning a worker of a plurality of workers to the worksite location;
assigning for each worker of the plurality of workers an activity of a plurality of activities at the worksite location;
transmitting the assignment and activity to each worker of the plurality of workers for display upon an electronic device associated with each worker;
receiving from each worker of the plurality of workers an acceptance of the assignment or an acceptable variation to the assignment;
automatically reconciling the acceptances and acceptable variations from the plurality of workers; and
transmitting the reconciled assignments and activities to the plurality of workers.

In accordance with an embodiment of the invention there is provided a method comprising:
establishing through a web based interface a geo-fenced region, the geo-fenced region established in dependence upon a worksite location;
monitoring through a wireless based location means whether a user is within or external to the geo-fenced region, the wireless based location means using a wireless receiver operating according to a first predetermined standard forming part of an electronic device associated with the user;
associating the user with the worksite location in dependence upon whether the user is within the geo-fenced region associated with the worksite location and storing with each association the time elapsed between the user's entry and exit from the geo-fenced region.

In accordance with an embodiment of the invention there is provided a method comprising associating a worker's activities with a worksite based upon determining whether the worker is within a geo-fenced region associated with the worksite.

In accordance with an embodiment of the invention there is provided a method of establishing whether a user is performing a predetermined action comprising receiving accelerometer data relating to the user and processing the accelerometer data to establish the presence of a characteristic feature within the accelerometer data relating to the predetermined action.

In accordance with an embodiment of the invention there is provided a method of remunerating a worker in dependence upon establishing the time the worker is within a geo-fenced location and that the worker is performing the task associated with them at that geo-fenced application.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts examples of prior art employee time tracking applications;

FIG. 2 depicts a simplified network within which embodiments of the invention may be employed;

FIG. 3 depicts a network environment within which embodiments of the invention may be employed;

FIG. 4 depicts a wireless portable electronic device supporting communications to a network such as depicted in FIG. 3 and as supporting embodiments of the invention;

FIG. 5 depicts an example of geo-fencing a worksite according to an embodiment of the invention;

FIGS. 6 and 7 depict examples of geo-location tracking to associate travel time and time at a secondary location with an allocated activity according to an embodiment of the invention;

FIGS. 8A and 8B depict exemplary screen images presented to a user of a mobile client application for time and activity tracking according to an embodiment of the invention;

FIGS. 9 to 11 depict exemplary screens presented to a user of a web application for time and activity tracking according to an embodiment of the invention;

FIG. 12 depicts an exemplary process flow for administrative configuration of staff, worksites, and activities together with mobile client communications to a server for web and client applications according to an embodiment of the invention;

FIG. 13 depicts an exemplary process flow for time tracking for staff, worksites, and activities together with mobile client communications to a server for web and client applications according to an embodiment of the invention;

FIG. 14 depicts an exemplary process flow integrating accelerometer and other sensor data within time tracking for staff, worksites, and activities together with mobile client communications to a server for web and client applications according to an embodiment of the invention;

FIG. 15 depicts interfacing for a web application for time and activity tracking according to an embodiment of the invention with interfaces to third party reporting software tools; and

FIG. 16 depicts the association of equipment through beacons and contact free interfaces with a time and activity tracking web application according to an embodiment of the invention.

### DETAILED DESCRIPTION

The present invention is directed to time and activity management systems and more particularly to systems and methods exploiting automatically acquired time and location in isolation or in combination with sensor data such as accelerometers.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

An “application” (commonly referred to as an “app”) as used herein may refer to, but is not limited to, a “software application” and an element of a “software suite” as used herein may refer to, but is not limited to, a computer program designed to allow an individual to perform an activity. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED for the purposes of presenting a micro-survey to a consumer and/or customer.

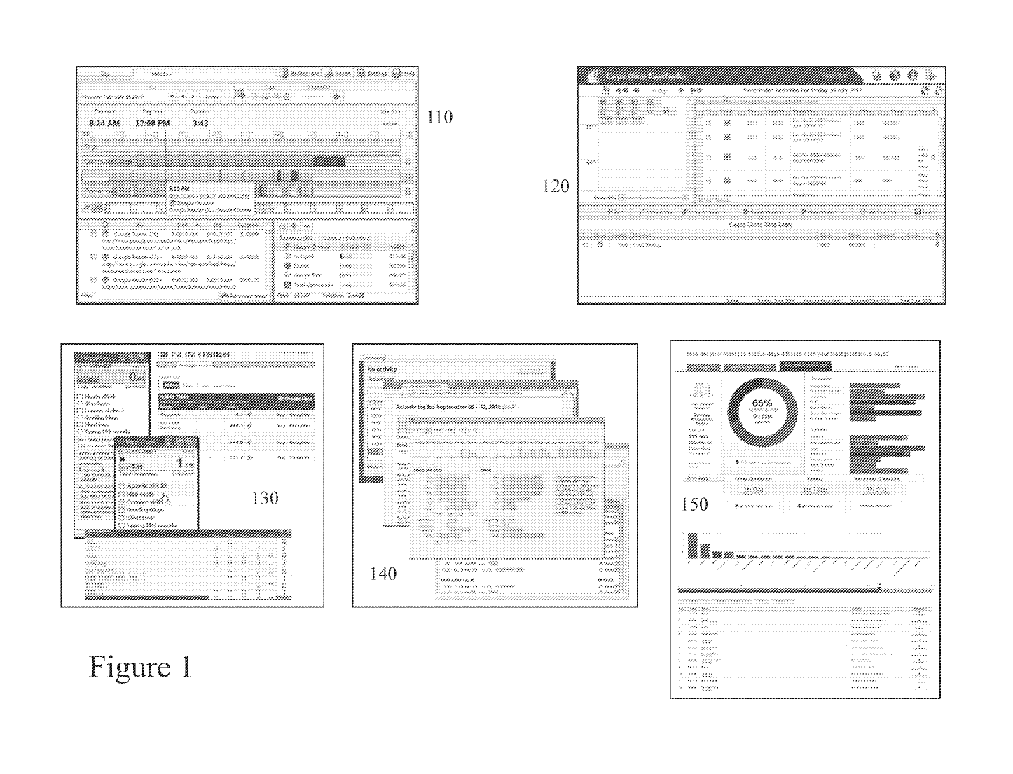

FIG. 1 depicts examples of prior art employee time tracking applications with first to fourth images 110 to 150 respectively. First image 110 being a screenshot from a prior art enterprise software tool where a user is presented with a dashboard that indicates visually their workday and indicates their computer usage, the applications they were using at each point in time and the documents that they were working upon at that point in time. Accordingly the software based upon data associating a particular document with a particular project and/or task (e.g. within the properties field of the document or by parsing the filename) can automatically allocate the user's time to a project and/or task. However, whilst a particular software application was in use and a specific document accessed was that what the individual was actually working on or not. Second image 120 relates to another enterprise application, Carpe Diem TimeFinder, which tracks a user's working time in a similar manner. However, if the individual is not logged into a PED/FED running the software then their activities are untracked and hence a second timekeeping application that the user enters time/task/project information into must be employed in parallel to either of these applications.

Third image 130 relating to “SLIMTIMER” provides a timekeeping solution applicable to PEDs wherein a user creates tasks and subsequently can enter the time they spent on that task at any time wherein the software then consolidates their entries daily, weekly, monthly etc. In this instance, the individual is now responsible for tracking what tasks they have been working on and for how long and hence third image 130 in common with fourth image 140 requires the individual to be tracking their activities whilst working or their memories when completing any timekeeping as they may perhaps complete their timesheet on a Friday, the next morning, or when finance rings and chases them at the end of the month perhaps. Fourth image 140 aims to ease the individual's recollection of task/project by associating tags to each task/project so that a user may identify the particular task/project by selecting a combination of tags. For example selecting “domination” and “global” associates with a project entitled “World Domination” whereas selecting “food” would allocate the user's time to “break”/“lunch.”

Fifth image 150 like first and second images 110 and 120 respectively provides time keeping functionality it also provides for increased summary perspective presentations of the user's activities with the intention of improving their time management and productivity. Accordingly, software applications etc. are associated with categories/activities such that the user can establish a quick dashboard perspective of their time such as what absorbs most time, how has their activity loading shifted over time, are they spending more than average on certain tasks etc. However, many employees/contract workers would find this invasive and “Big Brother”-like but for consultants, contract workers where they are paid perhaps on fixed cost basis of a task or upon how many contracts they complete rather than being salaried to an employer such tools may be beneficial.

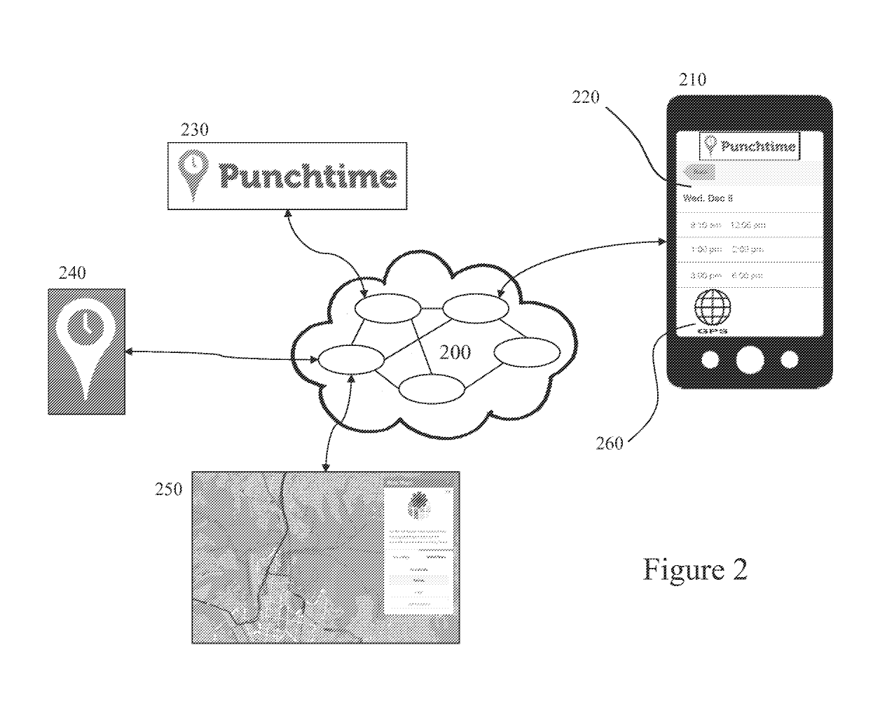

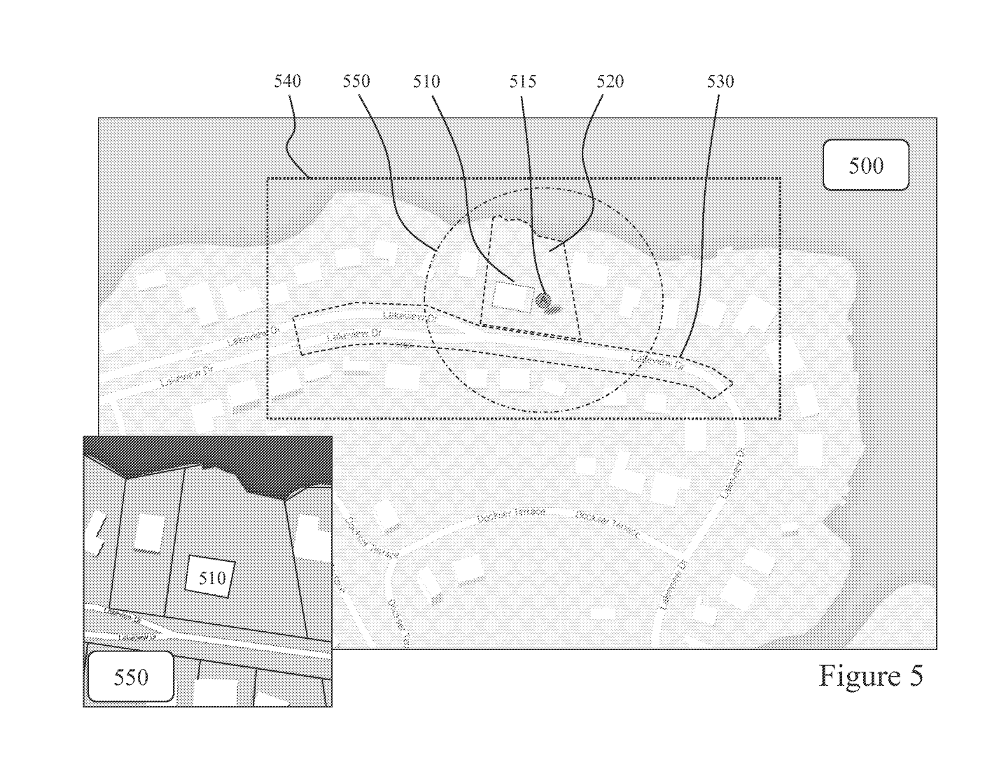

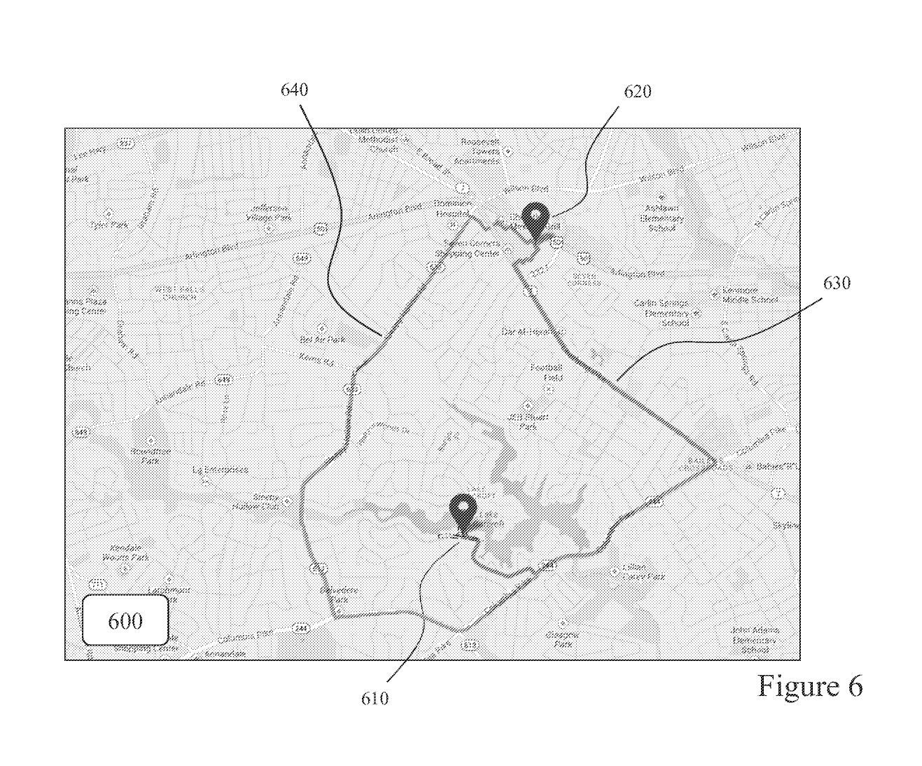

FIG. 2 depicts a simplified network within which embodiments of the invention may be employed. Accordingly, connected to a Network 200 is PED 210 associated with a user, not shown for clarity, executing a Punchtime Mobile Client Application (PunchMCA) 220 wherein the PED 210 provides global position system information, GPS 260, which as will become evident in respect of embodiments of the invention described below in respect of FIGS. 5 to 14, provides data to the PunchMCA 220. GPS 260 may also provide PunchMCA 220 with time/date information such that the PunchMCA 220 is independent of time/date on the user's PED 210. Also interfaced to the Network 200 are Punchtime™ web application 230, referred to as Punchtime Software as a Service (PunchSAAS) 230, which provides the remotely hosted services and applications necessary for managing the overall time keeping/activity/project management activities as well as supporting the PunchMCA 220 and the Punchtime Administration Client (PunchAC) 240 which allows an administrator to manage employees associated with the PunchSAAS 230, tasks, activities, etc. PunchSAAS 230 also accesses third party Application Programming Interface (API) (3PTYAPI) 250 in order to acquire additional information. Accordingly, an enterprise, individual, etc. may access the PunchSAAS 230 via PunchAC 240, itself accessed by the enterprise, individual, etc. by downloading PunchAC 240 or accessing PunchAC 240 via Network 200, allowing them to establish an account, associate staff to the account, establish tasks/activities etc. and begin tracking staff time against the tasks and activities.

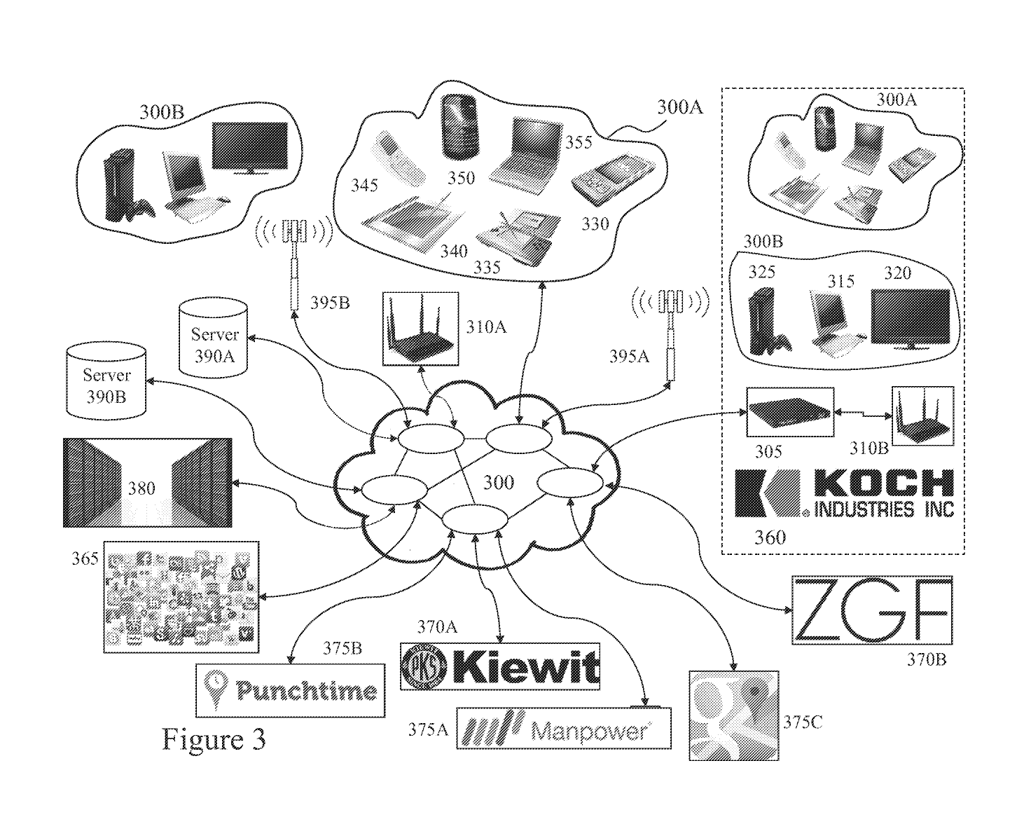

Referring to FIG. 3 there is depicted a network environment 300 within which embodiments of the invention may be employed supporting SOCMES and/or SOCNETS. As shown first and second user groups 300A and 300B respectively interface to a telecommunications network 300. Within the representative telecommunication architecture a remote central exchange 380 communicates with the remainder of a telecommunication service providers network via the network 300 which may include for example long-haul OC-48/OC-192 backbone elements, an OC-48 wide area network (WAN), a Passive Optical Network, and a Wireless Link. The central exchange 380 is connected via the network 300 to local, regional, and international exchanges (not shown for clarity) and therein through network 300 to first and second cellular APs 395A and 395B respectively which provide Wi-Fi cells for first and second user groups 300A and 300B respectively. Also connected to the network 300 are first and second Wi-Fi nodes 310A and 310B, the latter of which being coupled to network 300 via router 305. Second Wi-Fi node 310B is associated with Enterprise 360, e.g. Koch Industries Inc. an American based multinational employing approximately 50,000 people in the United States and approximately another 20,000 in 59 other countries, within which are other first and second user groups 300A and 300B. Second user group 300B may also be connected to the network 300 via wired interfaces including, but not limited to, DSL, Dial-Up, DOCSIS, Ethernet, G.hn, ISDN, MoCA, PON, and Power line communication (PLC) which may or may not be routed through a router such as router 305.

Within the cell associated with first AP 310A the first group of users 300A may employ a variety of PEDs including for example, laptop computer 355, portable gaming console 335, tablet computer 340, smartphone 350, cellular telephone 345 as well as portable multimedia player 330. Within the cell associated with second AP 310B are the second group of users 300B which may employ a variety of FEDs including for example gaming console 325, personal computer 315 and wireless/Internet enabled television 320 as well as cable modem 305. First and second APs 395A and 395B respectively provide, for example, cellular GSM (Global System for Mobile Communications) telephony services as well as 3G and 4G evolved services with enhanced data transport support. Second cellular AP 395B provides coverage in the exemplary embodiment to first and second user groups 300A and 300B. Alternatively the first and second user groups 300A and 300B may be geographically disparate and access the network 300 through multiple APs, not shown for clarity, distributed geographically by the network operator or operators. First cellular AP 395A as show provides coverage to first user group 300A and environment 370, which comprises second user group 300B as well as first user group 300A. Accordingly, the first and second user groups 300A and 300B may according to their particular communications interfaces communicate to the network 300 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-2000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly portable electronic devices within first user group 300A may form associations either through standards such as IEEE 802.15 and Bluetooth as well in an ad-hoc manner. PEDs/FEDs in first and second user groups 300A and 300B by virtue of wired and/or wireless network interfaces may access the Internet, e.g. Network 200, and accordingly the Punchtime Mobile Client Application (PunchMCA) 220 to provide data back to the Punchtime Software as a Service (PunchSAAS) 230 and/or the Punchtime Administration Client (PunchAC) 240 to configure aspects of the PunchSAAS 230 and PunchMCA 220.

Also connected to the network 300 are Social Networks (SOCNETS) 365, first and second service providers 370A and 370B respectively, e.g. Kiewit and Landis, and first to third party providers 375A to 375C respectively, e.g. Manpower™, PunchTime™, and Google Maps, as well as first and second servers 390A and 390B. First service provider 370A depicted as Kiewit is an employee-owned Fortune 500 contractor and one of the largest contractors in the world. First service provider 370A providing a service, in this instance construction services, to Enterprise 360. Second service provider 370B depicted as ZGF (Zimmer Gunsul Frasca Architects LLP) and accordingly is providing a service, in this instance construction services, to Enterprise 360. Considering the third party providers then first third party provider 375A, Manpower™ represents a staffing agency providing temporary/contract staff, second third party provider 375B Punchtime™ represents SAAS provider of time keeping/task activity services, and third party provider 375C Google Maps represents a provider of third party services, in this instance map services, to the second third party provider 375B Punchtime™ as opposed to the Enterprise 360 or the first and second service providers 370A and 370B respectively.

First and second servers 390A and 390B respectively which together with others, not shown for clarity, may host according to embodiments of the inventions multiple services associated with a provider of a SAAS time keeping/management service (e.g. Punchtime™ as represented by PunchSAAS 230 in FIG. 2, hereinafter PunchSAAS); a provider of a SOCNET or Social Media (SOME) exploiting PunchSAAS features; a provider of a SOCNET and/or SOME not exploiting PunchSAAS features; a provider of services to PEDS and/or FEDS; a provider of one or more aspects of wired and/or wireless communications; an Enterprise 360 exploiting PunchSAAS features; license databases; customer databases; websites; and software applications for download to or access by FEDs and/or PEDs exploiting and/or hosting PunchSAAS features. First and second primary content servers 390A and 390B may also host for example other Internet services such as a search engine, financial services, third party applications and other Internet based services.

Accordingly, a user consumer and/or customer (CONCUS) may exploit a PED and/or FED within an Enterprise 360, for example, and access one of the first or second primary content servers 390A and 390B respectively to execute an application which provides PunchSAAS features according to embodiments of the invention or execute an application already installed providing PunchSAAS features wherein their responses and/or demographic data are transmitted from the PED and/or FED immediately or subsequently. Subsequently, during use of the PED and/or FED the CONCUS may when executing an application providing PunchSAAS features enter a location such as that typified by Enterprise 360 thereby coming into wireless contact with first and second user groups 300A and 300B as well as first and second APs 310A and 310B respectively and first and second cellular APs 395A and 395B respectively. Accordingly, their physical location is captured irrespective of enabling any application providing PunchSAAS features with GPS location monitoring for example. Additionally, the user may exploit their own normal SOCNET and/or SOME during provisioning of PunchSAAS features or they may access a SOCNET and/or SOME associated with the Enterprise 360 and therein be provided with PunchSAAS features.

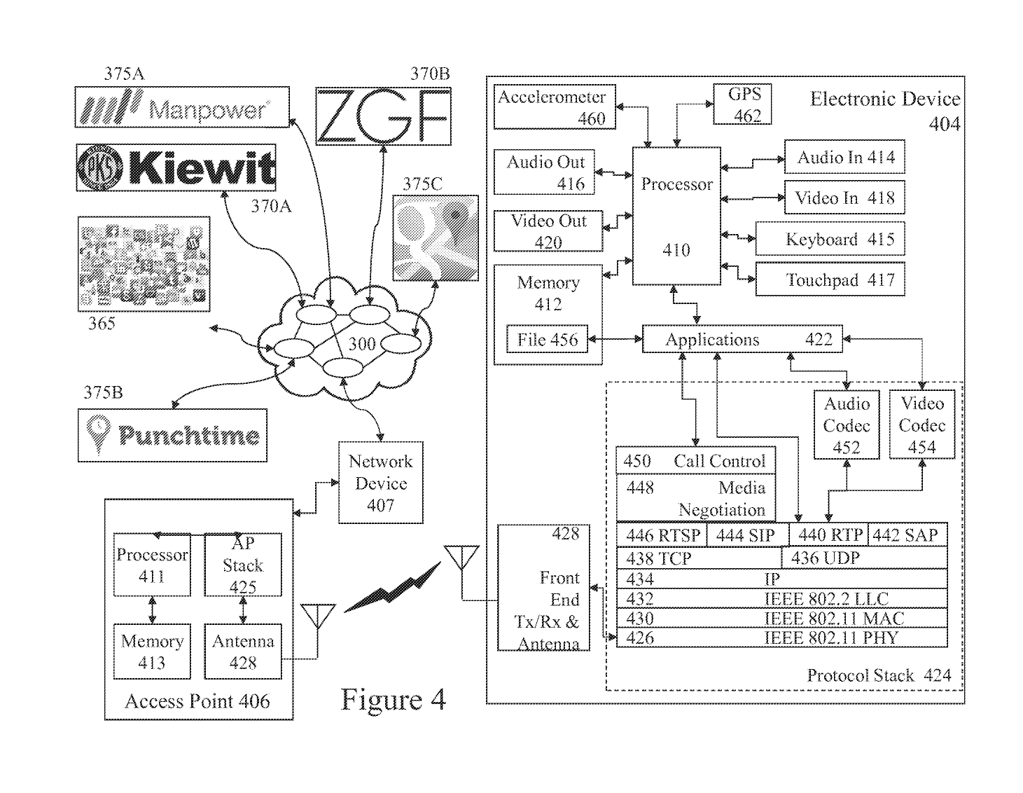

Now referring to FIG. 4 there is depicted an electronic device 404 and network access point 407 supporting PunchSAAS features according to embodiments of the invention. Electronic device 404 may, for example, be a PED and/or FED and may include additional elements above and beyond those described and depicted. Also depicted within the electronic device 404 is the protocol architecture as part of a simplified functional diagram of a system 400 that includes an electronic device 404, such as a smartphone 350, an access point (AP) 406, such as first AP 310, and one or more network devices 407, such as communication servers, streaming media servers, and routers for example such as first and second servers 390A and 390B respectively. Network devices 407 may be coupled to AP 406 via any combination of networks, wired, wireless and/or optical communication links such as discussed above in respect of FIG. 3 as well as directly as indicated. Network devices 407 are coupled to network 300 and therein Social Networks (SOCNETS) 365, first and second service providers 370A and 370B respectively, third party provider 375, and PunchSAAS provider 490.

The electronic device 404 includes one or more processors 410 and a memory 412 coupled to processor(s) 410. AP 406 also includes one or more processors 411 and a memory 413 coupled to processor(s) 410. A non-exhaustive list of examples for any of processors 410 and 411 includes a central processing unit (CPU), a digital signal processor (DSP), a reduced instruction set computer (RISC), a complex instruction set computer (CISC) and the like. Furthermore, any of processors 410 and 411 may be part of application specific integrated circuits (ASICs) or may be a part of application specific standard products (ASSPs). A non-exhaustive list of examples for memories 412 and 413 includes any combination of the following semiconductor devices such as registers, latches, ROM, EEPROM, flash memory devices, nonvolatile random access memory devices (NVRAM), SDRAM, DRAM, double data rate (DDR) memory devices, SRAM, universal serial bus (USB) removable memory, and the like.

Electronic device 404 may include an audio input element 414, for example a microphone, and an audio output element 416, for example, a speaker, coupled to any of processors 410. Electronic device 404 may include a video input element 418, for example, a video camera or camera, and a video output element 420, for example an LCD display, coupled to any of processors 410. Electronic device 404 also includes a keyboard 415 and touchpad 417 which may for example be a physical keyboard and touchpad allowing the user to enter content or select functions within one of more applications 422. Alternatively the keyboard 415 and touchpad 417 may be predetermined regions of a touch sensitive element forming part of the display within the electronic device 404. The one or more applications 422 that are typically stored in memory 412 and are executable by any combination of processors 410. Electronic device 404 also includes accelerometer 460 providing three-dimensional motion input to the processor 410 and GPS 462 which provides geographical location information to processor 410.

Electronic device 404 includes a protocol stack 424 and AP 406 includes a communication stack 425. Within system 400 protocol stack 424 is shown as IEEE 802.11 protocol stack but alternatively may exploit other protocol stacks such as an Internet Engineering Task Force (IETF) multimedia protocol stack for example. Likewise AP stack 425 exploits a protocol stack but is not expanded for clarity. Elements of protocol stack 424 and AP stack 425 may be implemented in any combination of software, firmware and/or hardware. Protocol stack 424 includes an IEEE 802.11-compatible PHY module 426 that is coupled to one or more Front-End Tx/Rx & Antenna 428, an IEEE 802.11-compatible MAC module 430 coupled to an IEEE 802.2-compatible LLC module 432. Protocol stack 424 includes a network layer IP module 434, a transport layer User Datagram Protocol (UDP) module 436 and a transport layer Transmission Control Protocol (TCP) module 438.

Protocol stack 424 also includes a session layer Real Time Transport Protocol (RTP) module 440, a Session Announcement Protocol (SAP) module 442, a Session Initiation Protocol (SIP) module 444 and a Real Time Streaming Protocol (RTSP) module 446. Protocol stack 424 includes a presentation layer media negotiation module 448, a call control module 450, one or more audio codecs 452 and one or more video codecs 454. Applications 422 may be able to create maintain and/or terminate communication sessions with any of devices 407 by way of AP 406. Typically, applications 422 may activate any of the SAP, SIP, RTSP, media negotiation and call control modules for that purpose. Typically, information may propagate from the SAP, SIP, RTSP, media negotiation and call control modules to PHY module 426 through TCP module 438, IP module 434, LLC module 432 and MAC module 430.

It would be apparent to one skilled in the art that elements of the electronic device 404 may also be implemented within the AP 406 including but not limited to one or more elements of the protocol stack 424, including for example an IEEE 802.11-compatible PHY module, an IEEE 802.11-compatible MAC module, and an IEEE 802.2-compatible LLC module 432. The AP 406 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 404 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-2000, DSL, Dial-Up, DOCSIS, Ethernet, G.hn, ISDN, MoCA, PON, and Power line communication (PLC).

Within embodiments of the invention relating to a time keeping management application, e.g. PunchSAAS 230 as described in respect of FIG. 2 and PunchSAAS in FIGS. 3 and 4, staff employ/access a Punchtime Mobile Client Application (PunchMCA) 220 to provide data back to the Punchtime Software as a Service (PunchSAAS) 230 as well as accessing a Punchtime Administration Client (PunchAC) 240 to configure aspects of the PunchSAAS 230 and/or PunchMCA 220. When an administrator is establishing a worksite within a PunchAC they may establish a geo-fence, i.e. a virtual perimeter for a real-world geographic area, in association with the worksite such that when a worker/staff is within the geo-fence they are considered “logged in” or “punched in” to that worksite and when they are outside the geo-fence they are considered “logged out” or “punched out” of the worksite. Accordingly, referring to FIG. 5 examples of geo-fences that may be established by an administrator within a PunchAC for a worksite are presented with respect to a worksite at 6392 Lakeview Drive, Falls Church, Va. defined by house outline 510 and marker 515 within map 500. Also depicted is first geo-fence 520 as established using a Google Maps API for this address as evident from a portion of an API Image 550 within the insert. A second geo-fence 530 has been established along a portion of Lakeview Drive to allow for the fact that the worker/staff may have to park on Lakeview Drive and return to their vehicle sporadically for tools, materials, etc. Alternatively, the administrator may establish third and fourth geo-fences 540 and 550 which may be default options within the PunchAC whereas accessing a third party API may, for example, be an advanced option or an upgrade option.

In many instances a worker may leave the geo-fenced area but may still be working and also working on the worksite associated with the current worksite as they are collecting supplies, materials, etc. Alternatively, they may have left the current worksite and be collecting materials for a subsequent worksite. Accordingly, the PunchSAAS should accommodate geo-location tracking to associate travel time and time at a secondary location with an allocated activity and/or worksite according to embodiments of the invention. As the worker leaves the worksite geo-fence 610 then PunchSAAS would “punch out” the worker from the worksite but continues tracking their GPS location along either first and second routes 630 and 640 respectively to offsite location 620. When the worker subsequently returns from offsite location 620 to worksite geo-fence 610 the PunchSASS may be configured to associate the offsite location 620 as an allowed subsidiary worksite to the primary worksite allocated for the worker. The association may be automatic or it may require administrator authorization to add the offsite location 620 as a subsidiary worksite. Alternatively, offsite location 620 may be parsed through a third party API wherein it is established that offsite location 620 is a Home Depot store. Then based upon the enterprise, worksite, and activity or a combination thereof the PunchSAAS performs an association process where a match to a predetermined criteria is met.

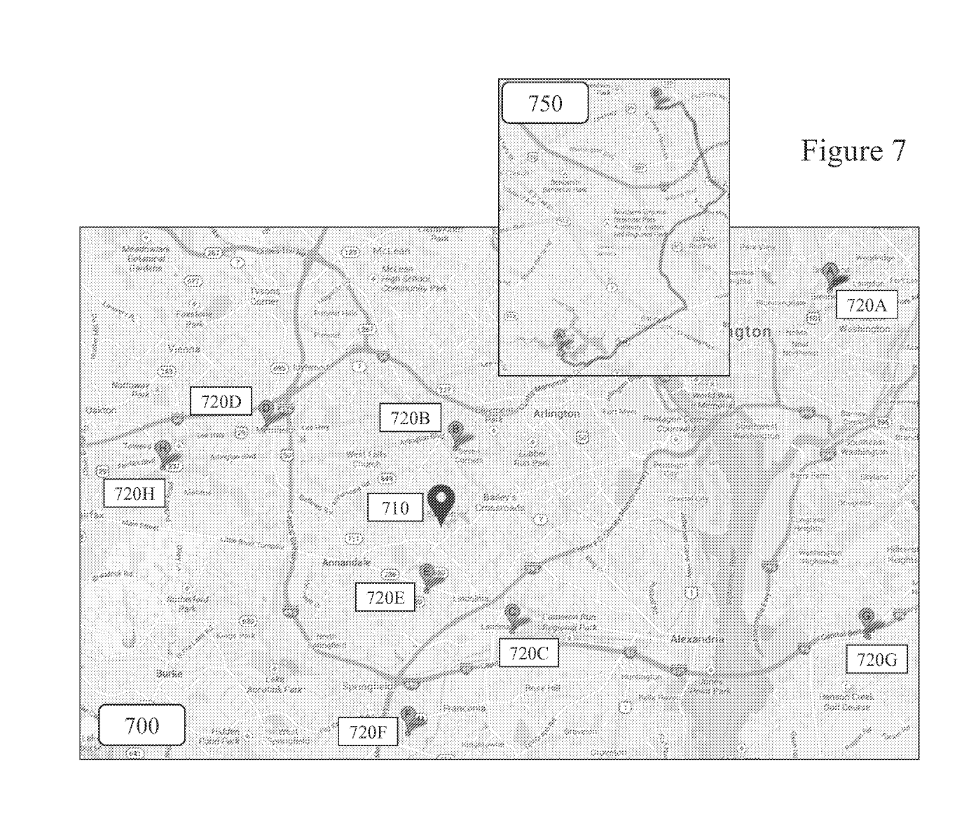

Within another embodiment of the invention an administrator may through the PunchSAAS establish a list of suppliers, partners, etc. wherein a worker may identify to the PunchMCA on their PED that they require materials for the worksite they are currently working at. Accordingly, as depicted in FIG. 7 the worker may be then presented upon their PED a map indicating the worksite 710 and locations of authorized (approved) suppliers, partners, etc. which are depicted as first to eighth locations 720A to 720H respectively. Such suppliers, partners, etc. may for example be those that the enterprise engaging the worker for the worksite 710 has an account with allowing the worker to purchase and/or collect pre-ordered materials, supplies etc. without having to worry about how it will be paid for as the enterprise will be invoiced by the supplier, partner etc. directly. Optionally, the worker in establishing via their PunchMCA that they require materials may be provided with the ability to access a bill of materials for the activity they are performing now or have been allocated to perform at the worksite 710 and upon selecting the material(s) they need be provided with a specific retailer and/or retailer location associated with the material(s) and then through a third party API directions for them to travel to the retailer from the worksite 710. Such an instance is shown in Insert 750 wherein the worker is provided with directions from worksite 710 to the Dominion Electric Supply Inc. located at 5053 Lee Highway, Arlington, Va. which is a supplier of commercial and domestic lighting fixtures.

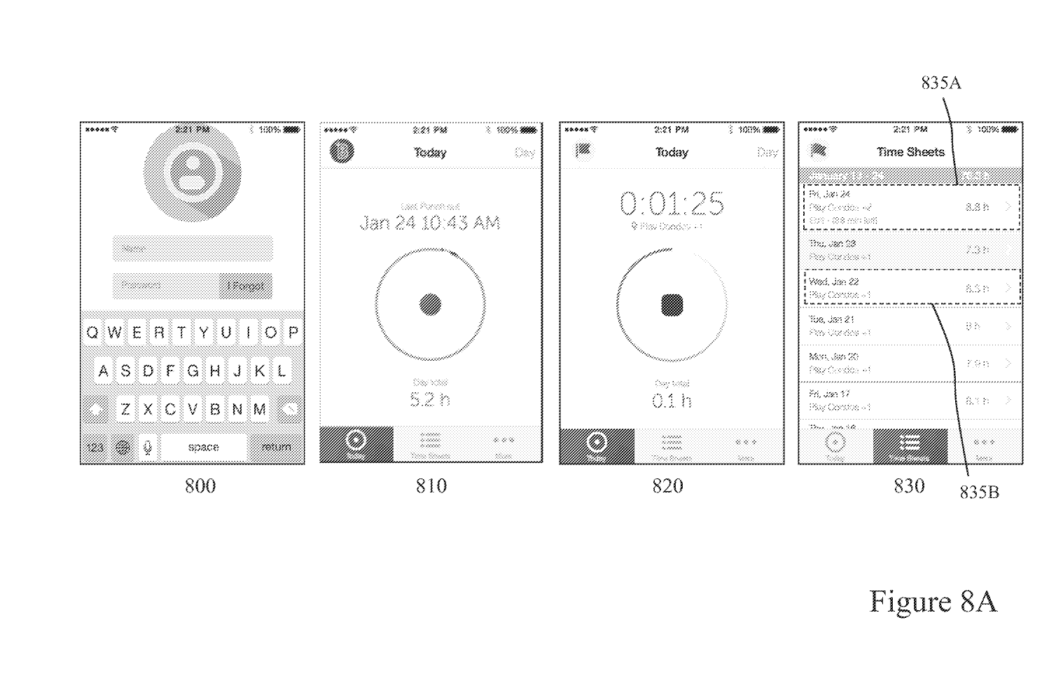

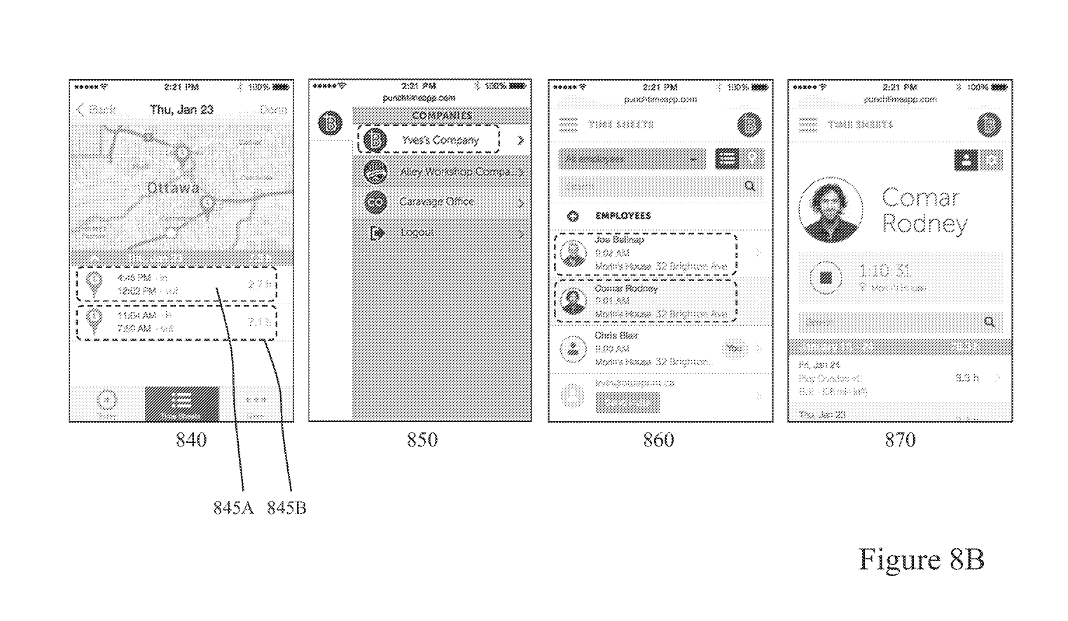

Referring to FIG. 8A there are depicted exemplary first to fourth screens 800 to 830 respectively presented to a user of a PunchMCA for time and activity tracking according to an embodiment of the invention. First screen 800 there is depicted a registration/login screen for the PunchMCA wherein the user can enter their registered name and password. If the registered name and password do not match then the PunchMCA may simply loop back to first screen 800 where the user's credentials are set up through a separate management interface. Alternatively, the PunchMCA proceeds to a screen (not shown) allowing the user to either retry their credentials or continue with a registration process. Upon entering valid registered name and password the PunchMCA may proceed to a menu screen, not shown, or to a company list (see below in respect of second image 850 in FIG. 8B. Now referring to second screen 810 the user is “punched out” and is shown the date and time of their last “punch-out” together with the total time worked that day. Optionally, additional information may be provided such as location of last worksite, next planned task/activity/worksite etc. Third screen 820 shows the user “punched in” at a worksite and indicating the time they have been “punched in” by the change within the symbol on the centre of the screen. Second and third screens 810 and 820 as depicted provide simple clear visual indicators of the user's “punch” status. The user is also given an indication of the time they have been punched in at the current location and the identity of the location, “Play Condos +1.” In fourth image 830 the user has accessed a log feature within the PunchMCA showing the last 12 days logged for the user together with their “punched in” time for that day, e.g. Friday, January 24 is indicated with 3.3 hours in first log entry 835A or Wednesday January 22 is indicated with 8.3 hours in second log entry 835B. Additionally, the user can view the total hours worked for the day range selected and access more work days. At the bottom of fourth screen 830 the user is presented with buttons linking them back to the current day's log, to timesheets outlining in more detail activities by day/project etc., and a button to link to menu screen with further options.

If the user taps a displayed day, e.g. Thursday January 23, then the user is presented with first screen 840 in FIG. 8B which shows the times on the selected day that they were “punched in” to a worksite such as first and second entries 845A and 845B respectively. First entry 845A defines a 2.7 hour entry for a first worksite and second entry 845B shows a 7.1 hour entry for a second website. If the user taps one of the map marker or work entry then they are presented with a further screen, optionally and not shown, that provides additional information with respect to the particular worksite. It would be evident based upon the discussions in respect of embodiments of the invention that the total time for a worksite may be comprised of multiple instances where the worker was logged into the worksite through the geo-fence aspects of embodiments of the invention. Accordingly, the user may actually have been at both worksites multiple instances that day. In second image 850 a user is presented with a screen listing companies that the user is “working” with or for or employed by allowing a contractor, for example, to track their time on multiple projects by employing party. Alternatively, a user may work for multiple employers and hence can track their time by employer. Within an embodiment of the invention a user upon entering a geo-fenced area is presented with second screen 850 in order to allocate their time to an employer/company where multiple options exist. Optionally, they may select multiple companies wherein the PunchMCA will attribute their time on site according to a predetermined rule across the multiple companies.

Third screen 860 represents a management user screen according to an embodiment of the invention with a PunchMCA wherein a user, for example manager, supervisor, owner, etc. can access records relating to their employees whilst out on a worksite or at another location to address queries etc. from customers. Within the list the user is also shown and the user has the option to add other users by invitation. Fourth screen 870 represents an example of a screen presented to the user when selecting another user associated with their company, in this instance Comar Rodney. This shows that Comar is currently on site at Morin's house, has been clocked in for just over 1 hour. The user can also view the history of Comar's activities by day and then select timesheet options for additional detail and information.

Optionally, the user may be provided with additional screens including, but not limited to, searching for logged time associated with a particular worksite or worksites and searching for logged time associate with a particular activity. Optionally, in instances where local, state, provincial, Federal regulations restrict maximum continuous “shifts” or maximum hours per day or within a predetermined period the PunchMCA may provide alarms to the user that such limits have been reached as well as potentially providing alarm communications in this respect to, for example, the enterprise hiring/employing the worker and the workers supervisor.

Optionally, when the user is “punched in” communications relating to the project, activity, location, task, user etc. may be presented to the user discretely or in combination with notices from SOCNETs. Optionally, the user may be required to “accept” indicating that they have received/read these messages otherwise the “punching in” process is not completed. Such communications may for example relate to regulatory issues for the worksite (e.g. hard hat required), issues for the worksite owner (e.g. work boots inside certain area), or issues for contractor (e.g. building inspector visit).

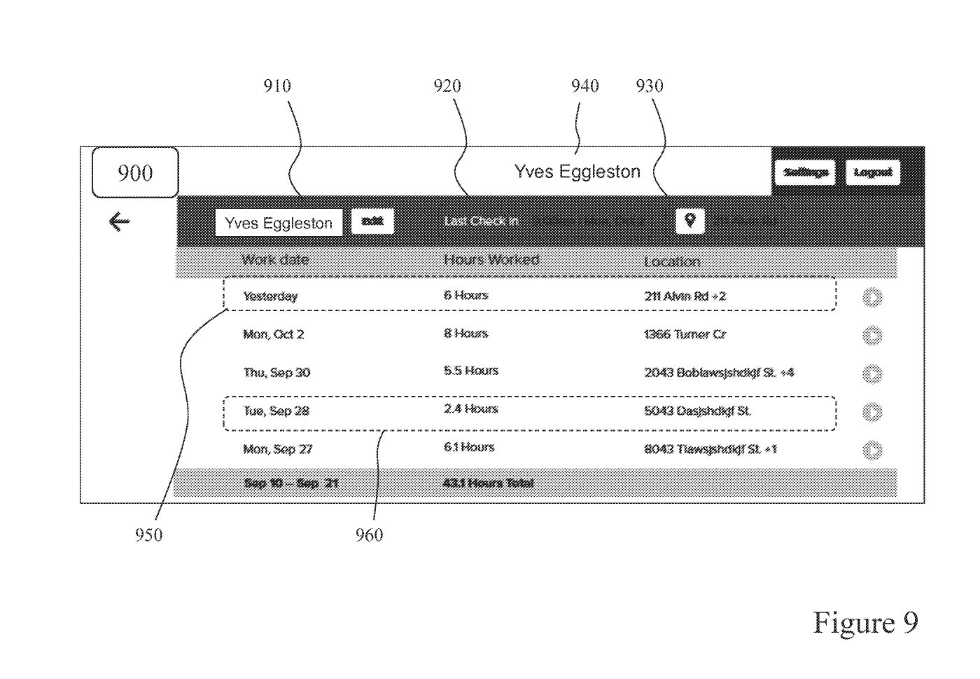

Referring to FIGS. 9 to 11 there are depicted exemplary first to third screenshots 900 to 1100 presented to a user of a web application for time and activity tracking according to an embodiment of the invention, e.g. PunchAC. In first screenshot 900 a user is presented with a workscreen relating to a worker 940, in this instance “Yves Eggleston” comprising Edit Field 910, Last Entry 920, and Location 930 together with a table of “punched in” entries for the worker 940 such as first and second entries 950 and 960 respectively. Edit Field 910 allows the user to change worker for example or select an enterprise and worker combination, e.g. a subsidiary and worker or worker and task. Last Entry 920 provides data relating to the last “punch in” of worker 940. Location 930 allows the user to select a worksite associated with the activities of the worker 940 and by selecting the icon view a map of the worksite together with its associated geo-fence(s) and location data for the worker 940. For example, the user may see that a worker has a low number of hours at a worksite, e.g. as indicated in second entry 960 with only 2.4 hours, and wish to see whether there was an issue with the geo-fence and/or location data.

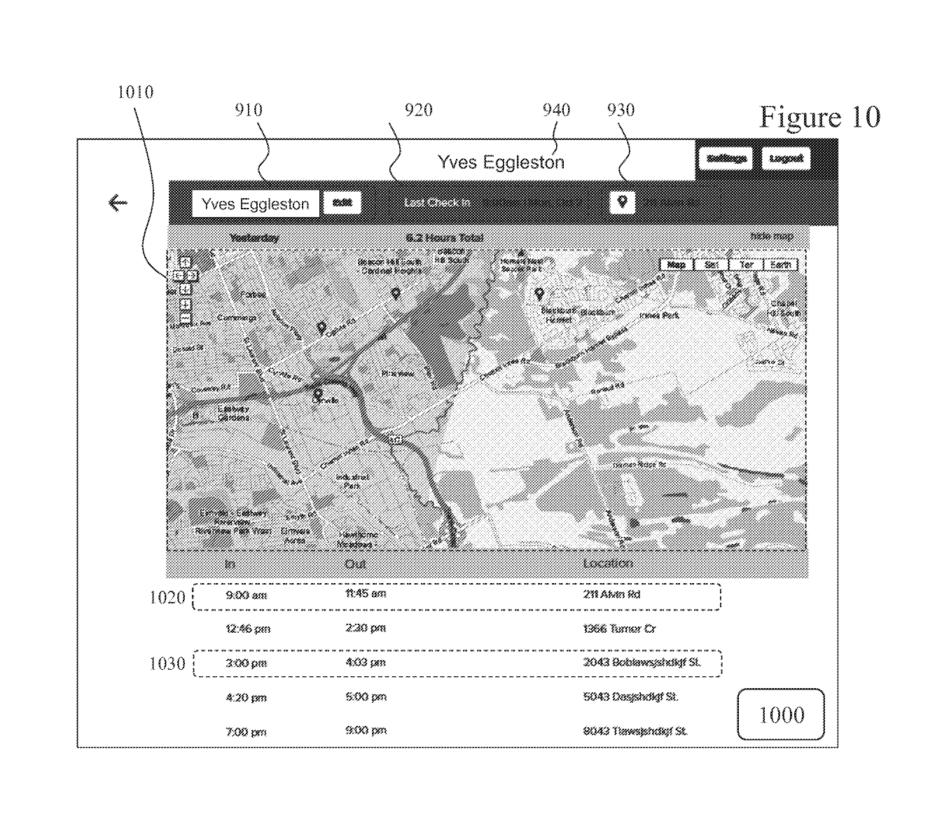

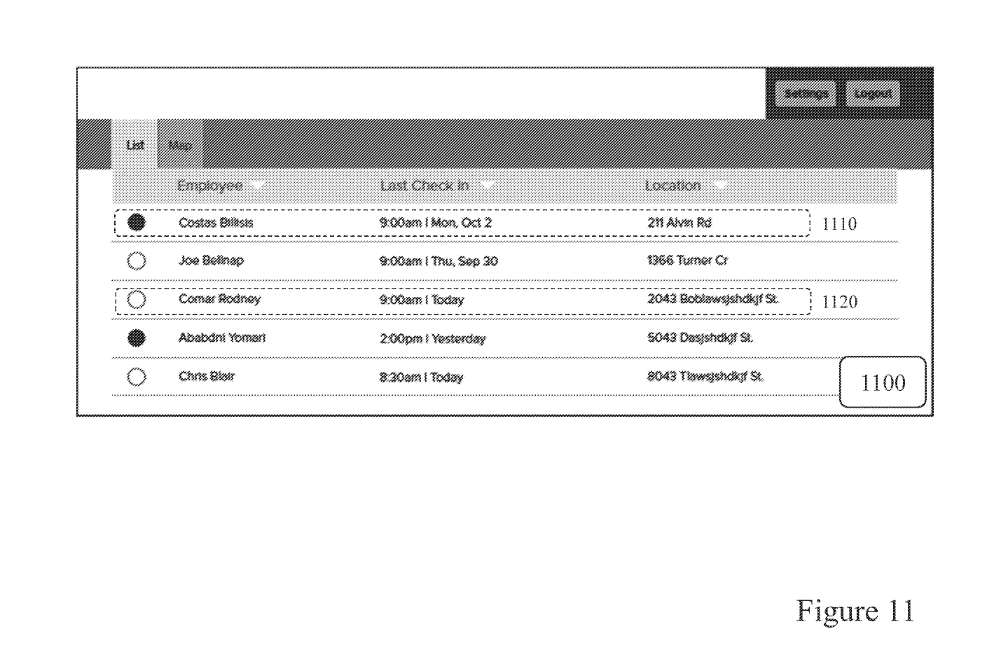

Second screenshot 1000 in FIG. 10 wherein a user has selected a specific day for the worker 940 resulting in map 1010 and a table of “punched in” times, including first and second entries 1020 and 1030. Optionally, addresses within the table may be identified by tags which match tags on the map 1010. Third screenshot 1100 in FIG. 11 depicts a workforce summary provided to a user of the PunchAC, or another web application associated with the PunchSAAS. Accordingly, a list of workers is provided, such as first and second entries 1110 and 1120 respectively, which indicate the name of a worker, their last “punched in” time, and the worksite associated with the last “punch in.” Third screenshot 1100 due to the nature of the PunchMCA, PunchSAAS, etc. would during the workday indicate current locations of workers. Optionally, where a current location for a “punched in” worker differs from the expected location of the worker set through the PunchAC then their entry on the third screenshot 1110 may be highlighted differently than the others or alternatively this discrepancy may be communicated from PunchSAAS to a supervisor, for example, via a text, email, etc.

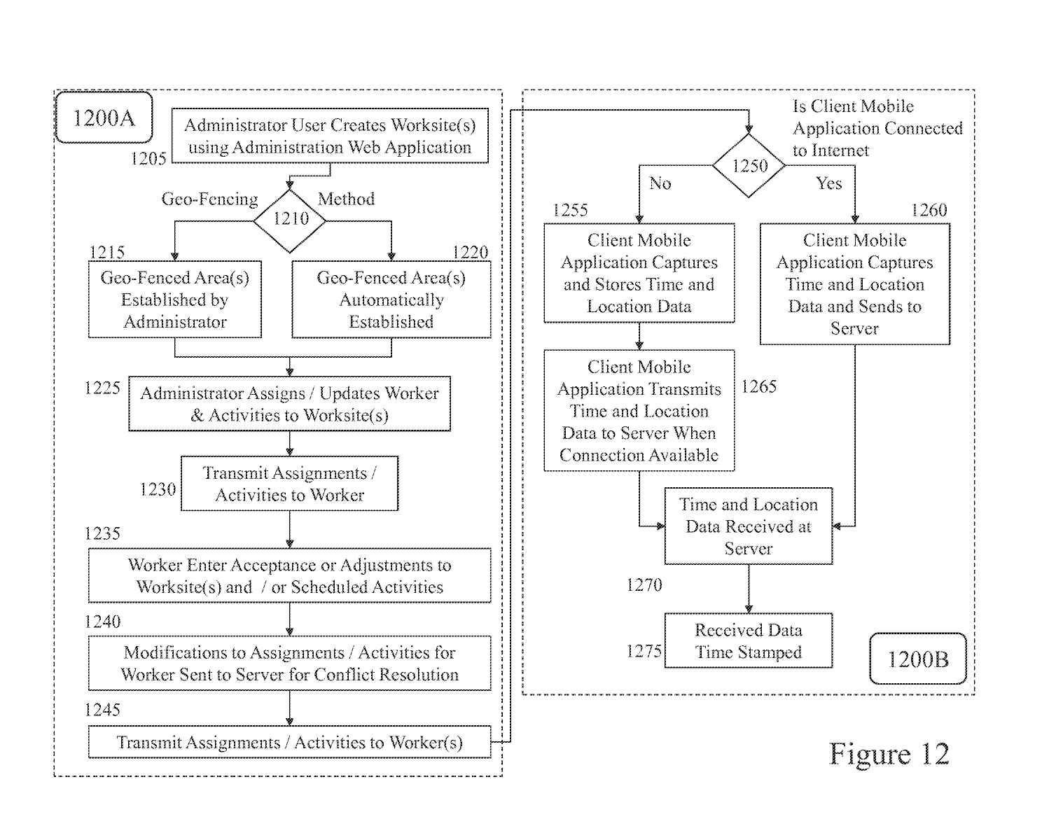

Referring to FIG. 12 there is depicted an exemplary process flow for administrative configuration of staff, worksites, and activities together with mobile client communications to a server for web and client applications according to an embodiment of the invention. As depicted, first sub-flow 1200A begins at step 1205 wherein an administrator establishes worksites within an administration web application, e.g. PunchAC before in step 1210 they select a method of establishing a geo-fence or geo-fences for the worksite. If the method selected was administrator set-up the process proceeds to step 1215 wherein the user may, for example, be presented with map of the worksite and surrounding area and through movement of a cursor, selection of a predetermined shape and adjustment, etc. defines the geo-fence. Alternatively, the user elects to have the geo-fence automatically established in step 1220 wherein, according to presets within the PunchSAAS, a predetermined routine is employed by the PunchSAAS to establish the geo-fence. As discussed supra such automated methods may include, but not be limited to, applying a predetermined geometrical fence to the worksite and extracting information from a third party API. From either step 1215 or step 1220 the process proceeds to step 1225 the administrator assigns or updates workers and activities to the worksite(s) wherein in step 1230 these assignments or revisions to the assignments are transmitted to the PunchMCA application in execution upon each workers PED. In step 1235 the worker either enters their acceptance of the worksite and/or scheduled activities or enters adjustments wherein these are transmitted to the PunchSAAS server(s) for conflict resolution. For example, a worker may be assigned to a worksite but has no transport and has agreed to work at a particular worksite due to another worker offering them a ride or a worker may have a personal conflict or be unable to perform the task allocated. Any subsequent adjustments to the assignments/activities of the worker(s) are then transmitted from the PunchSAAS to the PunchMCAs on their PEDs. First sub-flow 1200A then proceeds to step 1250 within second sub-flow 1200B wherein a determination is made as to whether a worker's PED is connected to the Internet so that it can communicate with the PunchSAAS. If yes then the process flow proceeds to step 1260 wherein the PunchMCA captures time and location information and sends it to the PunchSAAS server(s) wherein it is received at step 1270 wherein it is time stamped in step 1275. If the determination was negative then the second sub-flow 1200B proceeds to step 1255 wherein the PunchMCA captures time and location information which is stored upon the PED within the PunchMCA until the PED next communicates with the Internet and sends it to the PunchSAAS server(s) followed by steps 1270 and 1275. It would be evident that steps 1250 through 1275 may be repeated at a predetermined rate established by the PunchSAAS and/or PunchMCA together or in isolation.

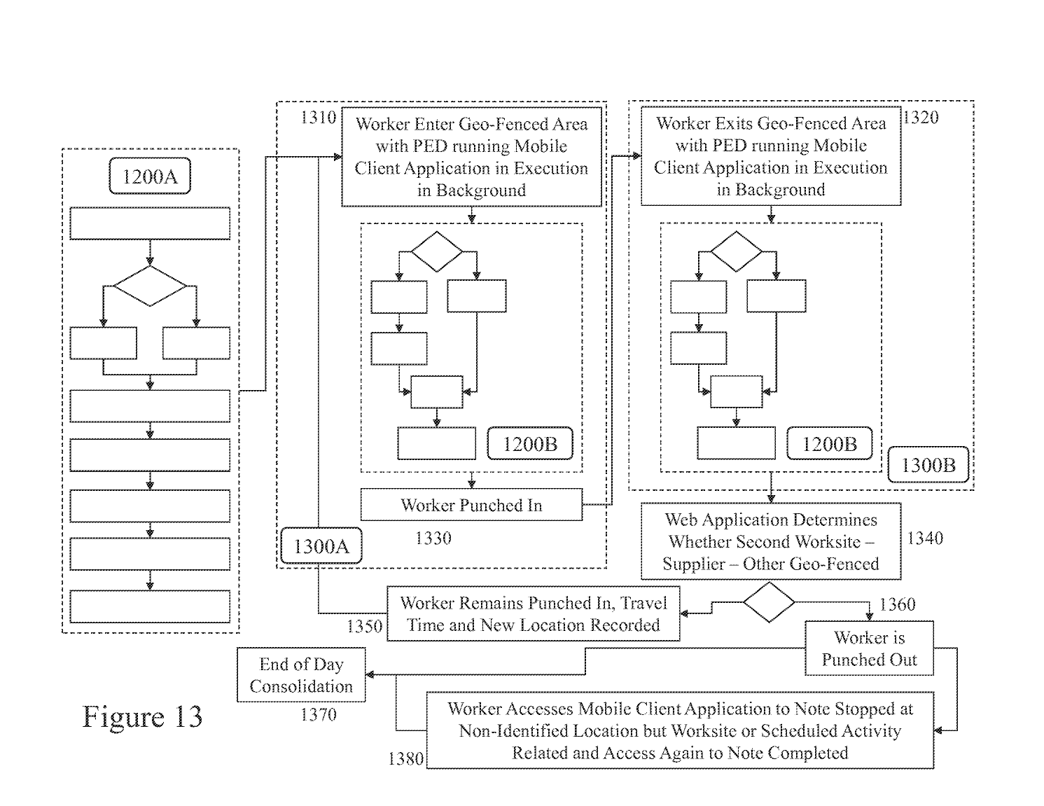

Now referring to FIG. 13 there is depicted an exemplary process flow for time tracking for staff, worksites, and activities together with mobile client communications to a server for web and client applications according to an embodiment of the invention. As depicted, the process flow begins with first sub-flow 1200A before proceeding to first geo-fence flow 1300A with step 1310 wherein the first geo-fence flow 1300A in execution on the PED through PunchMCA determines whether the worker has entered a geo-fenced area or not. If they are the process proceeds via second sub-flow 1200B to step 1330 wherein the worker is “punched in.” In second geo-fence flow 1300B in execution on the PED through PunchMCA determines whether the worker has exited the geo-fenced area or not. If they have exited the geo-fenced area then the process proceeds via second sub-flow 1200B to step 1340. In step 1340 the PunchSAAS system determines whether the worker is scheduled to a second worksite, supplier, or another geo-fenced area. If not scheduled, then the worker is “punched out” in step 1360 otherwise the process proceeds to step 1350 wherein the worker remains “punched in” and their travel time/new locations are recorded and the process loops back to first geo-fence flow 1300A wherein the user is “punched in” to either the original worksite when they return from the supplier or “punched in” to the second worksite. From step 1360 the process either proceeds directly to step 1370 wherein an end of day consolidation of worker times/worksites etc. is performed. If the worker, once “punched out” stops at a non-identified location but it is worksite or scheduled activity related then the user may in step 1380 start/stop the PunchMCA wherein this action is reported to the PunchMCA via time/location etc. and optionally any note(s) added by the worker. Such exceptions may require authorization before they are consolidated to the worker times for the worksite(s). From step 1380 the process proceeds to step 1370 but it may alternatively loop back to first geo-fence flow 1300A for example.

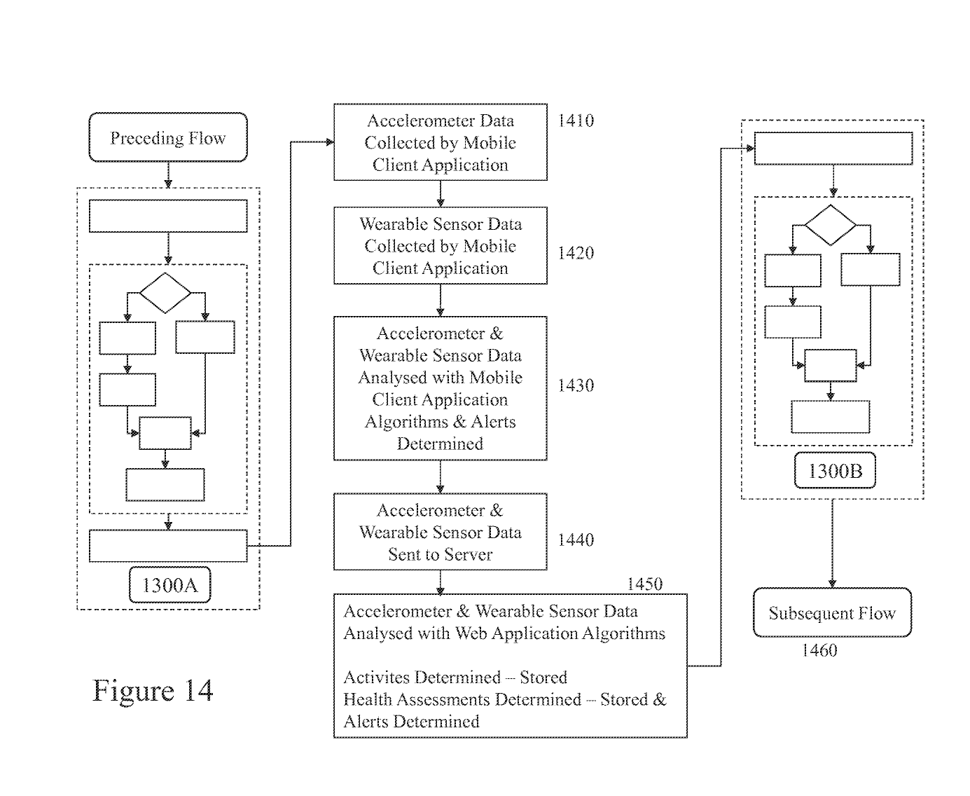

Now referring to FIG. 14 there is depicted an exemplary process flow integrating accelerometer and other sensor data within time tracking for staff, worksites, and activities together with mobile client communications to a server for web and client applications according to an embodiment of the invention. As depicted, the process proceeds from a preceding flow to first geo-fence 1300A before proceeding to step 1410 wherein accelerometer data is collected by the PunchMCA and then to step 1420 wherein additional sensor data, e.g. wearable sensor, data is collected by PunchMCA. This data is analysed in step 1430 with PunchMCA algorithms in order to determine whether any alerts should be triggered, e.g. 911 as the worker has suffered a heart attack. Subsequently, in step 1440 the accelerometer and sensor data are transferred to PunchSAAS server wherein they are processed 1450 with PunchSAAS algorithms allowing determination of the workers activities, health assessments to be determined as well as whether any additional alerts should be issued. The inventors have established that in an industry such as the construction industry, including but not limited to builders, decorators, bricklayers, and millworkers that the worker's activities may be classified to specific tasks in addition to the classification of other activities such as walking, climbing stairs, sitting etc. For example, hammering, sawing, painting have different accelerometer data/profiles to other activities allowing them to be classified through a variety of machine learning algorithms. Examples of prior art classifications to general activities include Yan et al. in “Energy-Efficient Continuous Activity Recognition on Mobile Phones: An Activity-Adaptive Approach” (16^{th} International Symposium Wearable Computers, 2012, pp. 17-24), Kwapisz et al in “Activity Recognition using Cell phone Accelerometers” (ACM SIGKDD Explorations Newsletter, 12(2), 74-82), and Yang in “Toward Physical Activity Diary: Motion Recognition using Simple Acceleration Features with Mobile Phones” (Proc. 1st Int. Workshop on Interactive Multimedia for Consumer Electronics, ACM, 2009, pp. 1-10). Optionally, a worker may be remunerated based upon not only the time they are within a geo-fenced location but that they are performing the task associated with them at that geo-fenced application.

The data relating to workers, their locations, worksites, activities, time, etc. described above in respect of embodiments of the invention relating to a single user as stored by a PunchSAAS may be automatically processed in order to generate a timesheet for the employee so that they can be paid, so that the worker activities can be consolidated with others to charge/report to a client etc. These reports may be generated by the PunchSAAS or these may be generated using a variety of standard reporting packages as the PunchSAAS outputs data in a recognized format to one or more of these tools.

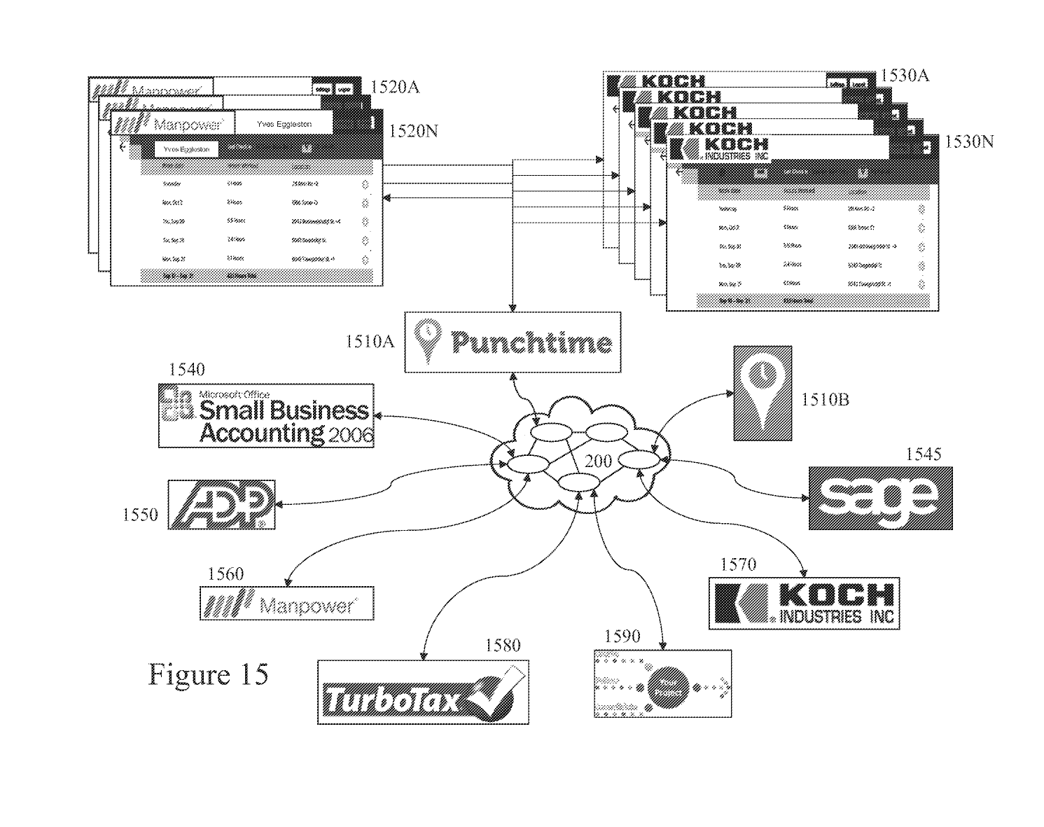

Accordingly, such interfacing for a web application for time and activity tracking according to an embodiment of the invention with interfaces to third party reporting software tools is depicted in FIG. 15 wherein a PunchSAAS 1510A accesses time and activity data relating to employees of an organization 1570, e.g. Koch Industries Inc., which is depicted as first timesheets 1520A to 1520N as well as time and activity data relating to contract employees of a contractor 1560, e.g. Manpower, which is depicted as second timesheets 1530A to 1530N. Accordingly, a user accessing a PunchAC 1510B may retrieve from PunchSAAS 1510A data relating to time and activities performed by personnel. This data may be extracted based upon a filter or plurality of filters including, but not limited to, a particular contractor, sub-contractor, third party service provider; a predetermined period of time; a predetermined location of work; a predetermined location of organization 1570, and a predetermined location of contractor 1560. The user may then export the filtered time and activity data via network 200 to one or more third party software packages and/or third party SAAS applications including, but not limited to, accounting software, represented as Microsoft Office Small Business Accounting 1540 and Sage 1545; tax return software, represented as TurboTax 1580; project management software, represented as Project Management Studio 1590; and payroll software, represented as ADP 1550. Accordingly, time and activity data may be exported to allow project management activities to track progress and costs as well as allowing timesheets to be automatically create, payroll runs to be automatically executed, tax return information to be automatically provided, etc.

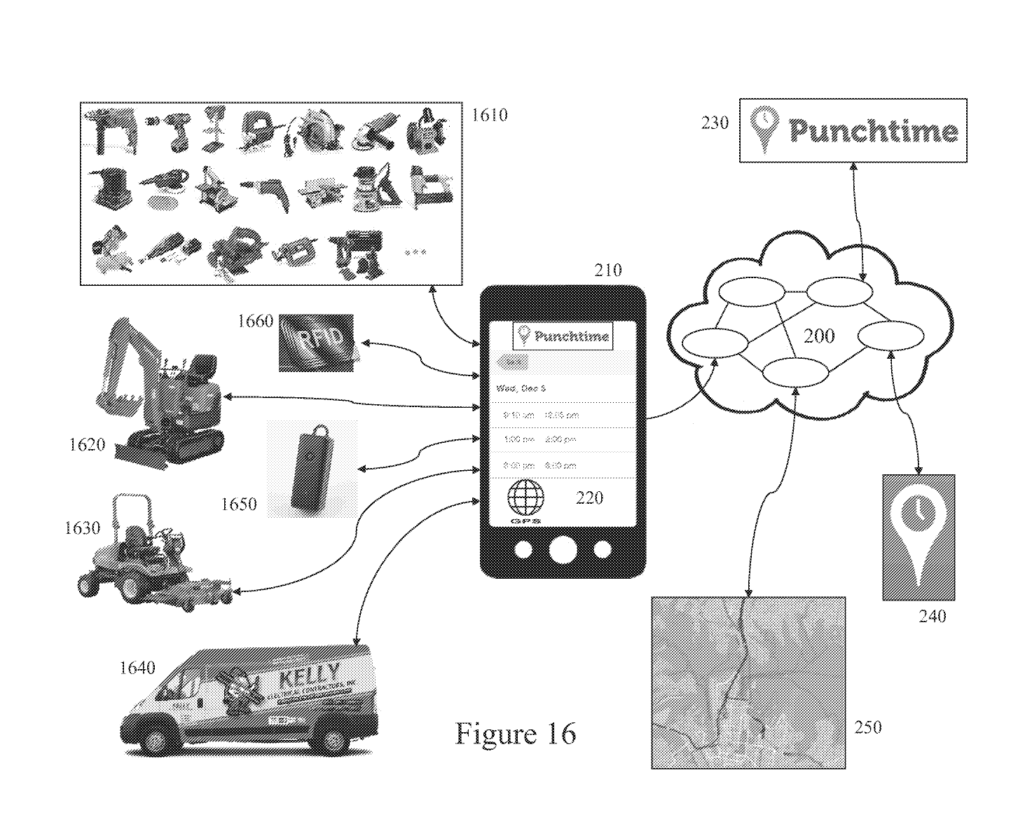

According to embodiments of the invention a PunchMCA provides users with a time and activity tracking web application and/or mobile device application allowing, for example, automated tracking of a user's activities against geo-fenced work locations. In some applications in addition to the location and timing information it is appropriate to have location defined more accurately than a GPS location or wireless triangulation for example or to have equipment used logged. Accordingly, considering FIG. 16 there is depicted a Network 200 wherein a PED 210 associated with a user, not shown for clarity, is executing a Punchtime Mobile Client Application (PunchMCA) 220. Also interfaced to the Network 200 are Punchtime™ web application 230, referred to as Punchtime Software as a Service (PunchSAAS), which provides the remotely hosted services and applications necessary for managing the overall time keeping/activity/project management activities as well as supporting the PunchMCA 220 and the Punchtime Administration Client (PunchAC) 240 which allows an administrator to manage employees associated with the PunchSAAS 230, tasks, activities, etc. PunchSAAS 230 also accesses third party Application Programming Interface (API) (3PTYAPI) 250 in order to acquire additional information.

Associated with a geo-fenced area may be beacons 1650, e.g. Bluetooth enabled beacons, that provide the PunchMCA 220 with, for example, short range associations such that the location of the PED 210 within the geo-fenced area is defined at higher specificity, e.g. a specific bedroom within a property being worked upon or business unit with a set of business units within a small area. Other specificities may be established, for example, by using Bluetooth Class 3 beacons for approximately 100 meter (˜330 feet) association to the PED 210 and therein PunchMCA 220, Bluetooth Class 2 for approximately 10 meter (˜33 feet) association, and Bluetooth Class 1 for approximately 1 meter (˜3 feet) association. In some instances equipment such as digger 1620, mower 1630, and van 1640 may have a beacon associated with them such that the user's use of the equipment and the time/duration they used the equipment is logged by the PunchMCA 220. To avoid incorrect associations due to proximity a minimum duration trigger may be associated with equipment or the beacon may only be enabled through operation of the actual piece of equipment. In other instances electrical power equipment 1610 may include an RFID tag 1660, or other near field communications (NFC) tag/interface, which provides a response to a near field communications (NFC) interface associated with the PED 210. For example, a 13.56 MHz ISM band provides 10 centimeter to 1 meter ranging whilst 865-868 MHz/902-928 MHz (Europe/North America) provides 1-10 meter ranging. Other ISM band RFID in the 2450-5800 MHz offers 1-2 meter range for RFID identification of equipment to the user. In the instances the PED 210 does not include an appropriate NFC/RFID interface then this may be integrated within a case or shell separately powered and/or powered by the PED 210 and interfaced through a wireless interface such as Bluetooth or through a wired interface.

In this manner the user's use of equipment may be logged, tracked and verified to either confirm particular work tasks were performed etc. or to address issues over loss, destruction, damage etc.

Within FIG. 3 SOCNETs are depicted as coupled to network 300 and communicating with first and second service providers 370A and 370B respectively, e.g. Kiewit and Landis, and first to third party providers 375A to 375C respectively, e.g. Manpower™, PunchTime™, and Google Maps, as well as first and second servers 390A and 390B and Enterprise 360. It would be evident that a project may be established as a SOCNET user group, e.g. a Facebook™ user, wherein all those being associated with the project are also invited to “Friend” the Facebook™ user allowing the SOCNET to host communications between those associated with the project without all requiring contact details of others on the project. Accordingly, a plumber could post at the end of the day that they need an additional hour the following morning thereby allowing the drywall gang to either offset their schedule by an hour before starting work or to be directed to another activity for a short period of time rather than their being left waiting for the plumber. Similarly, notices such as site inspections, regulatory inspections, building surveyors etc. may be posted to ensure that all workers are aware of these. Similarly, project photographs, etc. may be posted for others to view easily. Such SOCNETs with push-based communications being particularly suitable to these hosting activities.

Embodiments of the invention exploit location based information of the user's (worker's) PED. It would be evident that in many instances the location information may be derived from a global positioning system (GPS) which generally refers to Global Positioning Systems as operated by the U.S. Department of Defense. However, it would be evident that other location based systems employing satellite based navigation systems may be employed including, for example, the Russian Global Navigation Satellite System (GLONASS), European Union Galileo, Chinese Compass, and the Indian Regional Navigational Satellite System. However, other approaches including, but not limited to, triangulation, base station association, etc. may be employed without departing from the scope of the invention.

It would be evident to one skilled in the art that whilst descriptions have been provided with respect to embodiments of the invention from the viewpoint of the construction industry that the concepts described are applicable across a wide range of applications and industries. For example, a retailer with multiple locations may assign geo-fences to their retail locations and track staff with respect to these.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
establishing through a web based interface a geo-fenced region, the geo-fenced region established in dependence upon a worksite location;
monitoring through a wireless based location means whether a user is within or external to the geo-fenced region, the wireless based location means using a wireless receiver operating according to a first predetermined standard forming part of an electronic device associated with the user; and
associating the user with the worksite location in dependence upon whether the user is within the geo-fenced region associated with the worksite location and storing with each association the time elapsed between the user's entry and exit from the geo-fenced region.

2. The method according to claim 1, further comprising
determining whether the user when within the geo-fenced region is associated with an item of equipment, the association made using a first wireless transceiver operating according to a second predetermined standard associated with the electronic device and a second wireless transceiver operating according to the second predetermined standard associated with the item of equipment.

3. The method according to claim 2, wherein
the second wireless transceiver operating according to the second predetermined standard is one of a near field communications tag and a radio frequency identity tag; and
the first wireless transceiver operating according to the second predetermined standard forms part of a case for the electronic device.

4. The method according to claim 1, further comprising
establishing at least one of whether the user is performing and for how long the user is performing a predetermined action by receiving accelerometer data relating to the user and processing the accelerometer data to establish the presence of a characteristic feature within the accelerometer data relating to the predetermined action.

5. The method according to claim 1, further comprising
determining a remuneration to be provided to the user in dependence upon at least one of the time the user is within a geo-fenced location and the tasks associated with user's activities within the geo-fenced application.

6. The method according to claim 1, further comprising
establishing through a web based interface a second geo-fenced region, the second geo-fenced region established in dependence upon the worksite location but not forming part of the worksite location.

7. The method according to claim 1, further comprising
monitoring whether the user exits the geo-fenced region;
tracking the location of the user;
monitoring whether the user re-enters the geo-fenced region or enters another worksite location similarly defined by a geo-fenced region; and
associating the user with the worksite location or the another worksite location in dependence upon whether a destination within the route of the user established by tracking the location of the user after exiting the geo-fenced region before they re-enter the geo-fenced region or enter the another worksite location similarly defined by a geo-fenced region meets a predetermined criteria with respect to the worksite location or the another worksite location.

8. The method according to claim 1, further comprising
establishing a requirement relating to the worksite location;
automatically establishing a retailer supplying a product addressing the requirement in dependence upon at least one of the worksite location and an approved retailer identity.

9. A method comprising:
establishing a geo-fenced region, the geo-fenced region established in dependence upon a worksite location;
assigning a worker of a plurality of workers to the worksite location;
assigning for each worker of the plurality of workers an activity of a plurality of activities at the worksite location;
transmitting the assignment and activity to each worker of the plurality of workers for display upon an electronic device associated with each worker;
receiving from each worker of the plurality of workers an acceptance of the assignment or an acceptable variation to the assignment;
automatically reconciling the acceptances and acceptable variations from the plurality of workers; and
transmitting the reconciled assignments and activities to the plurality of workers.

10. The method according to claim 9, further comprising
monitoring through a wireless based location means whether each worker of the plurality of workers is within or external to the geo-fenced region, the wireless based location means using a wireless receiver operating according to a first predetermined standard forming part of an electronic device associated with each worker of the plurality of workers;
associating each worker of the plurality of workers with the worksite location in dependence upon whether each worker of the plurality of workers is within the geo-fenced region associated with the worksite location and storing with each association the time elapsed between each worker of the plurality of workers entering and exiting from the geo-fenced region.

11. The method according to claim 9, further comprising
monitoring through a wireless based means whether the worker of the plurality of workers is performing the activity, the wireless based location means using a wireless receiver operating according to a second predetermined standard forming part of an electronic device associated with each worker of the plurality of workers, wherein
the determination whether the worker of the plurality of workers is performing the activity is established in dependence upon at least one of receiving accelerometer data relating to the user through the second wireless interface and processing the accelerometer data to establish the presence of a characteristic feature within the accelerometer data relating to the activity.

12. The method according to claim 9, further comprising
determining whether the user when within the geo-fenced region is associated with an item of equipment, the association made using a first wireless transceiver operating according to a second predetermined standard associated with the electronic device and a second wireless transceiver operating according to the second predetermined standard associated with the item of equipment.

13. The method according to claim 12, wherein
the second wireless transceiver operating according to the second predetermined standard is one of a near field communications tag and a radio frequency identity tag; and
the first wireless transceiver operating according to the second predetermined standard forms part of a case for the electronic device.
